(19) United States
(12) Patent Application Publication
(10) Pub. No.: US 2021/0142636 A1
(43) Pub. Date: May 13, 2021

(54) THREE-DIMENSIONAL INTRUSION DETECTION SYSTEM AND THREE-DIMENSIONAL INTRUSION DETECTION METHOD

(71) Applicant: PANASONIC INTELLECTUAL PROPERTY MANAGEMENT CO., LTD., Osaka (JP)

(72) Inventor: Kazuhiro TSUBOTA, Kanagawa (JP)

(73) Assignee: PANASONIC INTELLECTUAL PROPERTY MANAGEMENT CO., LTD., Osaka (JP)

(21) Appl. No.: 16/488,640

(22) PCT Filed: Jan. 19, 2018
(86) PCT No.: PCT/JP2018/001492

§ 371 Date: Aug. 26, 2019

(30) Foreign Application Priority Data
Mar. 1, 2017 (JP) 2017-038136

(51) Int. Cl. G08B 13/196; G06K 9/00; H04N 7/18; G06T 19/00; G06T 7/593

(52) U.S. Cl. CPC G08B 13/19693; G08B 13/19641; G08B 13/19613; G06T 2207/30232; H04N 7/181; G06T 19/006; G06T 7/593; G06K 9/00771

(57) ABSTRACT

An observer simply performs operations as necessary such as confirmation as to whether or not erroneous detection is made and confirmation as to whether or not intrusion detection is normal, and the observer can efficiently execute the observation operation. An observation area is captured by at least two cameras separately disposed, a plurality of camera images are acquired, a three-dimensional measurement unit performs a three-dimensional measurement for measuring a three-dimensional position of an object in the observation area based on the camera images to generate three-dimensional information of the observation area, an intrusion detector detects an object intruding into the observation area based on a change in the three-dimensional information, and a screen generator generates a map image obtained by visualizing the three-dimensional information and a mark image indicating the object intruding into the observation area, and outputs an observation screen displaying an image selected by an input operation of a user in the camera image and the map image, and the mark image.

### TECHNICAL FIELD

The present disclosure relates to a three-dimensional intrusion detection system that acquires three-dimensional information of an observation area from a plurality of camera images obtained by capturing the observation area with at least two cameras separately disposed, and detects an object intruding into the observation area based on the three-dimensional information, and a three-dimensional intrusion detection method.

### BACKGROUND ART

An intrusion detection systems, in which a camera for capturing an observation area is disposed and an object such as a person who intrudes the observation area is detected by an image process of a camera image, is widely spread. In such an intrusion detection system, erroneous detection frequently occurs when an environment such as brightness changes, so that a technique capable of robust intrusion detection that is less susceptible to an environmental change is desired.

As a technique related to such intrusion detection, in the related art, there is known a technique in which a three-dimensional measurement for measuring a three-dimensional position of an object in an observation area is performed based on left and right camera images to acquire three-dimensional information of the observation area, and the object intruding into the observation area is detected based on the three-dimensional information (see PTL 1).

### CITATION LIST

### Patent Literature

PTL 1: Japanese Patent No. 3388087

### SUMMARY OF THE INVENTION

A certain degree of erroneous detection cannot be avoided with such intrusion detection. For this reason, in a case where an object intruding into the observation area is detected, it is desirable for the observer to confirm whether there is an erroneous detection. When erroneous detection frequently occurs, it is desirable for an observer to confirm whether intrusion detection is normally performed. In response to such a request, it is conceivable to display a camera image reflecting an actual situation of the observation area on an observation screen, and further to display an image visualizing three-dimensional information used for intrusion detection on an observation screen.

However, in the above-mentioned technique of the related art, in a case where an object intruding into the observation area is detected, only an alarm is simply issued, and no consideration has been given to a display of the left and right camera images, and an image obtained by visualizing three-dimensional information, on the observation screen. Therefore, there has been a problem that an observer cannot efficiently carry out the observation operation, and a burden on the observer increases.

Therefore, a main object of the present disclosure is to provide a three-dimensional intrusion detection system and a three-dimensional intrusion detection method in which an observer simply performs operations such as confirmation as to whether or not erroneous detection is made and confirmation as to whether or not intrusion detection is normal, and the observer can efficiently execute the observation operation.

A three-dimensional intrusion detection system of the present disclosure is a three-dimensional intrusion detection system that acquires three-dimensional information of an observation area from a plurality of camera images obtained by capturing the observation area with at least two cameras separately disposed, and detects an object intruding into the observation area based on the three-dimensional information, the system including: an image acquisition unit acquiring a plurality of camera images; a three-dimensional measurement unit that performs three-dimensional measurement for measuring a three-dimensional position of the object in the observation area based on the plurality of camera images, and outputs the three-dimensional information of the observation area; an intrusion detector detecting the object intruding into the observation area based on a change situation of the three-dimensional information; and a screen generator that generates a map image obtained by visualizing the three-dimensional information and a mark image indicating the object intruding into the observation area, and outputs an observation screen displaying at least one image of the camera image and the map image selected by an input operation of a user, and the mark image.

A three-dimensional intrusion detection method of the present disclosure is a three-dimensional intrusion detection method that causes an information processing device to acquire three-dimensional information of an observation area from a plurality of camera images obtained by capturing the observation area with at least two cameras separately disposed, and detect an object intruding into the observation area based on the three-dimensional information, the method including: acquiring the plurality of camera images; performing three-dimensional measurement for measuring a three-dimensional position of the object in the observation area based on the plurality of camera images, and generating the three-dimensional information of the observation area; detecting the object intruding into the observation area based on a change situation of the three-dimensional information; and generating a map image obtained by visualizing the three-dimensional information and a mark image indicating the object intruding into the observation area, and outputting an observation screen displaying at least one image of the camera image and the map image selected by an input operation of a user, and the mark image.

According to the present disclosure, it is possible for the observer to confirm whether or not there is an erroneous detection by the camera image obtained by reflecting an actual situation of the observation area, and confirm whether or not the intrusion detection is normal based on the three-dimensional information by the map image visualizing three-dimensional information. The observer can perform customization in which the observer selects an image to be displayed on the observation screen. Therefore, as necessary, the observer can easily perform confirmation as to whether or not there is an erroneous detection and confirmation as to whether or not the intrusion detection is normal, and the observer can efficiently carry out the observation operation.

### BRIEF DESCRIPTION OF DRAWINGS

FIG. 1 is an overall configuration diagram of a three-dimensional intrusion detection system according to an exemplary embodiment.

FIG. 2 is an explanatory view illustrating an example of a detection region and a gazing region set on a camera image.

FIG. 3 is an explanatory diagram illustrating an outline of a process performed by server 2.

FIG. 4 is a block diagram illustrating a schematic configuration of server 2.

FIG. 5 is an explanatory view illustrating an observation screen in a two-division display mode.

FIG. 6A is an explanatory view illustrating an observation screen of a single image display mode.

FIG. 6B is an explanatory view illustrating an observation screen in the single image display mode.

FIG. 7 is an explanatory view illustrating an observation screen of a four-division display mode.

### DESCRIPTION OF EMBODIMENTS

The first invention for solving the above problems has a configuration in which a three-dimensional intrusion detection system that acquires three-dimensional information of an observation area from a plurality of camera images obtained by capturing the observation area with at least two cameras separately disposed, and detects an object intruding into the observation area based on the three-dimensional information, the system including: an image acquisition unit acquiring a plurality of camera images; a three-dimensional measurement unit that performs three-dimensional measurement for measuring a three-dimensional position of the object in the observation area based on the plurality of camera images, and outputs the three-dimensional information of the observation area; an intrusion detector detecting the object intruding into the observation area based on a change situation of the three-dimensional information; and a screen generator that generates a map image obtained by visualizing the three-dimensional information and a mark image indicating the object intruding into the observation area, and outputs an observation screen displaying at least one image of the camera image and the map image selected by an input operation of a user, and the mark image.

According to the configuration, the observer can confirm whether or not there is an erroneous detection by the camera image reflecting the actual situation of the observation area, and the observer can confirm whether or not the intrusion detection is normal based on the three-dimensional information by the map image which visualizes the three-dimensional information. The observer can perform customization in which the observer selects an image to be displayed on the observation screen. Therefore, as necessary, the observer can easily perform confirmation as to whether or not there is an erroneous detection and confirmation as to whether or not the intrusion detection is normal, and the observer can efficiently carry out the observation operation.

A second invention has a configuration in which the three-dimensional intrusion detection system further including: a region setting unit setting a gazing region on the camera image in accordance with an input operation of the user, in which the screen generator displays at least one image of the map image and the camera image on the observation screen in a state where a display range is limited to the gazing region.

According to the configuration, the visibility of the camera image and the map image is improved, and the observation operation can be efficiently performed by limiting the display range of the camera image and the map image to the gazing region that is important in the observation operation.

A third invention has a configuration in which the region setting unit sets a measurement region to be a target of the three-dimensional measurement in a range that includes a detection region to be a target of the intrusion detection and is the same as the gazing region.

According to the configuration, since the measurement region is set to include the detection region, the intrusion detection can be appropriately performed based on the three-dimensional information generated by the three-dimensional measurement. In addition, since the measurement region is set in the same range as the gazing region, it is only necessary to calculate and display the map image of the gazing region, so that a load on a three-dimensional information process can be reduced, and speeding up of a screen display process and cost reduction of the device can be achieved.

A fourth invention has a configuration in which the screen generator outputs a screen of a two-division display state in which any of the plurality of camera images and the map image are displayed together, as the observation screen.

According to the configuration, the camera image and the map image can be largely displayed by reducing the number of images displayed on the observation screen, so that the visibility of the camera image and the map image is improved, and the observation operation can be efficiently performed.

A fifth invention has a configuration in which the screen generator displays an operation portion for switching the observation screen on the observation screen, and switches a screen for displaying only a single camera image, a screen for displaying only the map image, and a screen of the two-division display state in response to an operation of the operation portion by the user.

According to the configuration, the observer can switch the observation screen according to an application.

The sixth invention has a configuration in which a three-dimensional intrusion detection method that causes an information processing device to acquire three-dimensional information of an observation area from a plurality of camera images obtained by capturing the observation area with at least two cameras separately disposed, and detect an object intruding into the observation area based on the three-dimensional information, the method including: acquiring the plurality of camera images; performing three-dimensional measurement for measuring a three-dimensional position of the object in the observation area based on the plurality of camera images, and generating the three-dimensional information of the observation area; detecting the object intruding into the observation area based on a change situation of the three-dimensional information; and generating a map image obtained by visualizing the three-dimensional information and a mark image indicating the object intruding into the observation area, and outputting an observation screen displaying at least one image of the camera image and the map image selected by an input operation of a user, and the mark image.

According to the configuration, as in the first invention, an observer simply performs operations such as confirmation as to whether or not erroneous detection is made and confirmation as to whether or not intrusion detection is normal, and the observer can efficiently execute the observation operation.

Hereinafter, exemplary embodiments will be described with reference to the drawings.

FIG. 1 is an overall configuration diagram of a three-dimensional intrusion detection system according to an exemplary embodiment.

The three-dimensional intrusion detection system includes a pair of left and right cameras 1, and server 2 (three-dimensional intrusion detection device, information processing device).

Camera 1 captures an observation area. A synchronization signal for left and right cameras 1 to capture at the same timing is output from one camera 1 to the other camera 1.

Server 2 performs a three-dimensional measurement for measuring a three-dimensional position of an object reflected to a camera image based on the left and right camera images output from left and right cameras 1, and detects an object such as a person who intrudes into the observation area based on the three-dimensional information of the observation area acquired by the three-dimensional measurement.

Cameras 1 are monocular cameras, and are separately disposed in the left and right at a predetermined distance. A large distance between two cameras 1 can be secured with such a configuration, so that three-dimensional information with depth can be obtained, which is suitable for wide area observation.

On the other hand, in such a configuration, different from a stereo camera (binocular camera) in which two cameras are housed in one housing, calibration (correction) for generating accurate three-dimensional information is performed in a state of being installed at a site. Since a positional relationship between two cameras 1 is easily shifted due to an influence of vibration, strong wind, or the like, calibration is performed at an appropriate timing after installation.

Server 2 may be connected to camera 1 via a network, so that server 2 installed at a remote place can perform intrusion detection. Although the configuration by a pair of left and right cameras is illustrated as cameras 1, it can also be configured by three or more cameras. In that case, more accurate three-dimensional information can be acquired for the observation area.

Next, the detection region and the gazing region set on the camera image will be described. FIG. 2 is an explanatory view illustrating an example of the detection region and the gazing region.

In the present exemplary embodiment, based on the left and right camera images output from left and right cameras 1, three-dimensional measurement is performed to measure the three-dimensional position of the object reflected to the camera image, and three-dimensional information obtained by the three-dimensional measurement is used to perform the intrusion detection.

The detection region to be a target of the intrusion detection is set on the camera image. The detection region is a three-dimensional space in which an object such as a person to be the detection target is present, and is a box-shaped (polyhedron) space defined by a bottom surface (floor surface) such as the ground and a height.

In the imaging region (entire region reflected to the camera image), a region particularly important in the observation operation, that is, a gazing region to be watched by the observer is set. The gazing region is a range of the camera image to be displayed on the observation screen. The gazing region is set to include the detection region.

A measurement region to be a target of the three-dimensional measurement is set. In the present exemplary embodiment, the measurement region is set to the same range as that of the gazing region.

The detection region and the gazing region are set in accordance with an input operation of the user who designates each range. When the user designates the range of the detection region, the gazing region (measurement region) may be automatically set to include the detection region.

In the example illustrated in FIG. 2, a rectangular gazing region is set to share left and right sides of the camera image, but the gazing region can be set at any position on the camera image. In addition, the shape of the gazing region is not limited to the rectangle, and the gazing region can be set to any shape.

Next, a process performed by server 2 will be described. FIG. 3 is an explanatory diagram illustrating an outline of the process performed by server 2.

Server 2 first acquires the left and right camera images (frames) output from left and right cameras 1, and cuts out the gazing region (measurement region) from the left and right camera images to acquire a partial camera image. The three-dimensional measurement is performed using the partial camera image, and three-dimensional information of each time corresponding to the frame is generated. The three-dimensional information may be generated by appropriately thinning the frame.

Next, the intrusion detection which detects the object intruding into the detection region is performed based on a change situation of the three-dimensional information of each time. The region of the intruding object is detected by comparing the three-dimensional information of each time with the three-dimensional information of a background acquired in a state where there is no intruded object, and position information (three-dimensional position) of the intruding object is acquired. The intrusion detection may be executed in combination with a detection function from the captured image of each camera 1.

Next, a partial depth map (map image) is generated in which three-dimensional information of the gazing region is visualized based on three-dimensional information acquired by three-dimensional measurement. A frame image (mark image) surrounding the intruding object is generated, and an image synthesis is performed in which the frame image is superimposed on the position of the intruding object in the partial camera image based on the position information of the intruding object acquired by the intrusion detection. An observation screen is generated in which the partial camera image and the partial depth map after the image synthesis are displayed together.

In the example illustrated in FIG. 3, the left partial camera image is displayed on the observation screen, but the right partial camera image may be displayed on the observation screen.

As described above, in the present exemplary embodiment, the intrusion detection is performed using the three-dimensional information acquired by the three-dimensional measurement, so that as illustrated in FIG. 2, the gazing region (measurement region) is set to include the detection region. Since an amount of calculation in the three-dimensional measurement or the like increases as the gazing region (measurement region) increases, the gazing region (measurement region) may be a rectangle circumscribing the detection region.

In the present exemplary embodiment, the measurement region is set to the same range as that of the gazing region, but the measurement region may be set to a range different from that of the gazing region. In this case, the gazing region may be set to include the detection region, and the measurement region may be set to include the gazing region. Therefore, the frame image which is the detection result of the intrusion detection can be displayed without omission on the observation screen, and it is not necessary to perform three-dimensional measurement again when the partial depth map is displayed on the observation screen.

Next, a schematic configuration of server 2 will be described. FIG. 4 is a block diagram illustrating a schematic configuration of server 2.

Server 2 includes image input unit 11 (image acquisition unit), controller 12, storage unit 13, display unit 14 (display device), and operation input unit 15.

The left and right camera images output from left and right cameras 1 are input to image input unit 11.

Storage unit 13 stores the camera image input to image input unit 11, the depth map generated by controller 12, and the like. Storage unit 13 also stores a program to be executed by controller 12.

Display unit 14 is formed of a display device such as a liquid crystal display. Operation input unit 15 is formed of an input device such as a keyboard and a mouse.

Controller 12 includes region setting unit 21, three-dimensional measurement unit 22, intrusion detector 23, and screen generator 24. Controller 12 is configured by a processor, and each unit of controller 12 is realized by executing a program stored in storage unit 13.

Region setting unit 21 sets the detection region and the gazing region in accordance with an input operation by the user in operation input unit 15. The user may individually designate the range of the detection region and the gazing region, but the user designates the range of the detection region, and region setting unit 21 may set the range of the gazing region based on the range of the detection region.

Three-dimensional measurement unit 22 performs the three-dimensional measurement for measuring the three-dimensional position of the object in the gazing region (measurement region) set by region setting unit 21 based on the left and right camera images input to image input unit 11, and generates the three-dimensional information of the gazing region.

Intrusion detector 23 detects the intruding object intruding into the detection region set by region setting unit 21 based on the three-dimensional information acquired by three-dimensional measurement unit 22.

Screen generator 24 generates the observation screen displayed on display unit 14 based on the three-dimensional information acquired by three-dimensional measurement unit 22, the detection result by intrusion detector 23, and the gazing region set by region setting unit 21. According to the input operation by the user in operation input unit 15, the display mode of the observation screen is switched to generate the observation screen according to the display mode.

Next, the observation screen displayed on display unit 14 will be described. FIG. 5 is an explanatory view illustrating an observation screen of the two-division display mode. FIGS. 6A and 6B are explanatory views illustrating an observation screen of a single image display mode (camera image display mode and depth map display mode). FIG. 7 is an explanatory view illustrating an observation screen of a four-division display mode.

As illustrated in FIGS. 5 to 7, the observation screen is provided with tabs 31 to 34 (operation portions) of “two-division”, “camera”, “depth”, and “four-division”.

When tab 31 of “two-divided” is operated, the observation screen of the two-division display mode illustrated in FIG. 5 is displayed.

In the observation screen in the two-division display mode, partial camera image 41 and partial depth map 42 (map image) are displayed together on image display unit 35. Partial camera image 41 is obtained by cutting out the gazing region from the camera image acquired from camera 1. The intruding object intruding into the observation area is reflected to partial camera image 41, and frame image 43 (mark image) indicating the intruding object is displayed based on the detection result of the intrusion detection. Partial depth map 42 visualizes the three-dimensional information of the gazing region generated by three-dimensional measurement unit 22 and, similar to partial camera image 41, is displayed in a state of being limited to the gazing region.

Information (detection information) or the like related to the intrusion detection such as capturing time and capturing location may be displayed on the observation screen. In this case, necessary information may be displayed in a margin, or may be displayed superimposed on partial camera image 41 or partial depth map 42.

As described above, in the two-division display mode, partial camera image 41 and partial depth map 42 are simultaneously displayed. Here, the observer can visually confirm the intruding object by observing partial camera image 41. Therefore, the observer can determine whether or not an erroneous detection occurs to detect an object other than the detection target. For example, in a case where a bird is reflected to partial camera image 41 and the bird is displayed on frame image 43, the observer can determine that the bird is erroneously detected as a person.

It is possible to visually confirm whether or not the intrusion detection is normally performed by observing partial depth map 42. If partial depth map 42 is abnormal, intrusion detection performed based on the original three-dimensional information also becomes abnormal. The observer can estimate a cause of the erroneous detection by visually comparing partial camera image 41 with partial depth map 42.

When tab 32 of “camera” is operated, an observation screen of a camera image display mode illustrated in FIG. 6A is displayed.

In the observation screen of the camera image display mode, only camera image 44 is displayed on image display unit 35.

In the two-division display mode illustrated in FIG. 5, partial camera image 41 limited to the gazing region is displayed, and in the camera image display mode, the camera image acquired from camera 1 is displayed as it is, and the entire imaging region can be observed. As in the two-division display mode, frame image 43 indicating the intruding object is displayed.

When tab 33 of “depth” is operated, an observation screen of a depth map display mode illustrated in FIG. 6B is displayed.

In the observation screen of the depth map display mode, only partial depth map 42 is displayed on image display unit 35. Partial depth map 42 is displayed in a state of being limited to the gazing region, as in the two-division display mode illustrated in FIG. 5. A region outside the gazing region in the imaging region is displayed in gray out around partial depth map 42. Therefore, the observer can confirm the position of the gazing region in the imaging region. Frame image 43 indicating the intruding object is displayed on partial depth map 42.

When tab 34 of “four-division” is operated, the observation screen of the four-division display mode illustrated in FIG. 7 is displayed.

In the observation screen of the four-division display mode, left camera image 44, right camera image 45, depth map 46 (map image), and information display column 47 are displayed on image display unit 35.

Left camera image 44 and right camera image 45 are obtained from left and right cameras 1. Depth map 46 is generated based on the three-dimensional information acquired by the three-dimensional measurement for the entire imaging region as a target. Character information related to information (detection information) regarding the intrusion detection such as a capturing time, a capturing location, or the like is displayed on information display column 47.

As illustrated in FIGS. 5 to 7, button 36 of “setting” is provided on the observation screen. When button 36 of “setting” is operated, the screen changes to a setting screen (not illustrated). In the setting screen, the user can perform designation of various setting items and, for example, the user can designate the ranges of the detection region and the gazing region (see FIG. 2).

As described above, in the present exemplary embodiment, the display mode of the observation screen can be switched according to the application by operating respective tabs 31 to 34 of “two-division”, “camera”, “depth”, and “four-division”. In an initial state of the observation screen, it is preferable to display the observation screen of the two-division display mode illustrated in FIG. 5.

In the two-division display mode illustrated in FIG. 5, partial camera image 41 and partial depth map 42 limited to the gazing region are displayed, and the number of displayed images is smaller than that of the four-division display mode illustrated in FIG. 7. Since the image is displayed in a large size in the two-division display mode, the situation of the observation area can be closely and precisely observed, and the observation operation can be efficiently performed.

In the two-division display mode illustrated in FIG. 5 and the depth map display mode illustrated in FIG. 6B, partial depth map 42 limited to the gazing region is displayed. The gazing region (measurement region) is set to include the detection region, so that when partial depth map 42 is displayed on the screen, it is not necessary to perform the process of the three-dimensional measurement again. Therefore, a load of the process can be reduced.

In the four-division display mode illustrated in FIG. 7, in order to display depth map 46 of the entire imaging region, when the mode is switched to the four-division display mode, the process of the three-dimensional measurement is performed again for the entire imaging region as a target. Therefore, it may be the partial depth map limited to the gazing region as in FIG. 6B.

In the present exemplary embodiment, the left camera image is displayed on the observation screen of the two-division display mode or the camera image display mode, but the right camera image may be displayed. An operation portion such as a button for switching the camera image may be provided on the observation screen, so that the left camera image and the right camera image can be switched.

It may be detected that the three-dimensional information is abnormal, and a message prompting the calibration of camera 1 may be displayed on the observation screen. In this case, in addition to the manual calibration in which the user designates various parameters, automatic calibration, in which controller 12 sets various parameters, is also possible.

In the present exemplary embodiment, as illustrated in FIG. 5 and the like, frame image 43 indicating the intruding object detected by the intrusion detection is displayed on the camera image, but the frame image may be displayed on the depth map. The frame image may be displayed on both the camera image and the depth map.

In the present exemplary embodiment, as illustrated in FIG. 6B, partial depth map 42 limited to the gazing region is displayed in the depth map display mode, but the depth map for the entire imaging region as a target may be displayed. In this case, when switching the display mode, the process of the three-dimensional measurement is performed again for the entire imaging region as a target.

In the present exemplary embodiment, the display mode is switched by operating tabs 31 to 34 (operation portions) displayed on the observation screen, but the display mode may be switched using an input device such as an operation key without using such a screen operation.

As described above, the exemplary embodiment is described as an example of the technique disclosed in the present application. However, the technique in the present disclosure is not limited to the exemplary embodiment, and can be applied to embodiments in which changes, replacements, additions, omissions, and the like are made. It is also possible to combine respective component elements described in the exemplary embodiment, and to set the elements as a new embodiment.

For example, although the pair of left and right cameras 1 is installed in the above exemplary embodiment, the number of cameras is not limited to the exemplary embodiment, and at least two (plural) cameras may be provided. That is, three or more cameras can be installed to generate the three-dimensional information from three or more camera images, which can improve the accuracy of the three-dimensional information.

In the above exemplary embodiment, rectangular frame image 43 surrounding the intruding object is displayed as the mark image indicating the intruding object on the observation screen. However, the mark image is not limited to the rectangle, and may have various shapes such as a circle. The mark image is not limited to the form surrounding the intruding object, and the intruding object may be indicated by an arrow image or the like.

### INDUSTRIAL APPLICABILITY

The three-dimensional intrusion detection system and the three-dimensional intrusion detection method according to the present disclosure is useful as a three-dimensional intrusion detection system and a three-dimensional intrusion detection method, in which an observer simply performs operations such as confirmation as to whether or not erroneous detection is made and confirmation as to whether or not intrusion detection is normal, and the observer can efficiently execute observation operation, the three-dimensional information of the observation area is acquired from a plurality of camera images obtained by capturing the observation area with at least two cameras separately disposed, and an object intruding into an observation area is detected based on the three-dimensional information.

### REFERENCE MARKS IN THE DRAWINGS

1 CAMERA
2 SERVER (INFORMATION PROCESSING DEVICE)
11 IMAGE INPUT UNIT (IMAGE ACQUISITION UNIT)
12 CONTROLLER
13 STORAGE UNIT
14 DISPLAY UNIT
15 OPERATION INPUT UNIT
21 REGION SETTING UNIT
22 THREE-DIMENSIONAL MEASUREMENT UNIT
23 INTRUSION DETECTOR
24 SCREEN GENERATOR
41 PARTIAL CAMERA IMAGE
42 PARTIAL DEPTH MAP (MAP IMAGE)
43 FRAME IMAGE (MARK IMAGE)
44 CAMERA IMAGE
45 CAMERA IMAGE
46 DEPTH MAP
47 INFORMATION DISPLAY COLUMN

1. A three-dimensional intrusion detection system that acquires three-dimensional information of an observation area from a plurality of camera images obtained by capturing the observation area with at least two cameras separately disposed, and detects an object intruding into the observation area based on the three-dimensional information, the system comprising:
an image acquisition unit acquiring a plurality of camera images;
a three-dimensional measurement unit that performs three-dimensional measurement for measuring a three-dimensional position of the object in the observation area based on the plurality of camera images, and outputs the three-dimensional information of the observation area;
an intrusion detector detecting the object intruding into the observation area based on a change situation of the three-dimensional information; and
a screen generator that generates a map image obtained by visualizing the three-dimensional information and a mark image indicating the object intruding into the observation area, and outputs an observation screen displaying at least one image of the camera image and the map image selected by an input operation of a user, and the mark image.

2. The three-dimensional intrusion detection system of claim 1, further comprising:
a region setting unit setting a gazing region on the camera image in accordance with an input operation of the user,
wherein the screen generator displays at least one image of the map image and the camera image on the observation screen in a state where a display range is limited to the gazing region.

3. The three-dimensional intrusion detection system of claim 2,
wherein the region setting unit sets a measurement region to be a target of the three-dimensional measurement in a range that includes a detection region to be a target of the intrusion detection and is the same as the gazing region.

4. The three-dimensional intrusion detection system of claim 2,
wherein the screen generator outputs a screen of a two-division display state in which any of the plurality of camera images and the map image are displayed together, as the observation screen.

5. The three-dimensional intrusion detection system of claim 4,
wherein the screen generator displays an operation portion for switching the observation screen on the observation screen, and switches a screen for displaying only a single camera image, a screen for displaying only the map image, and a screen of the two-division display state in response to an operation of the operation portion by the user.

6. A three-dimensional intrusion detection method that causes an information processing device to acquire three-dimensional information of an observation area from a plurality of camera images obtained by capturing the observation area with at least two cameras separately disposed, and detect an object intruding into the observation area based on the three-dimensional information, the method comprising:
acquiring the plurality of camera images;
performing three-dimensional measurement for measuring a three-dimensional position of the object in the observation area based on the plurality of camera images, and generating the three-dimensional information of the observation area;
detecting the object intruding into the observation area based on a change situation of the three-dimensional information; and
generating a map image obtained by visualizing the three-dimensional information and a mark image indicating the object intruding into the observation area, and outputting an observation screen displaying at least one image of the camera image and the map image selected by an input operation of a user, and the mark image.
